(19) United States
(12) Patent Application Publication
(10) Pub. No.: US 2008/0151871 A1
(43) Pub. Date: Jun. 26, 2008

(54) Power-Efficient Multi-Branch Reception

(75) Inventors: Ulo Parts, Helsinki (FI); Juha Heiskala, Helsinki (FI); Mikko Kokkonen, Helsinki (FI)

Correspondence Address: BRAKE HUGHES BELLERMANN LLP, c/o INTELLEVATE, P.O. BOX 52050, MINNEAPOLIS, MN, 55402, US

(73) Assignee: Nokia Corporation, Espoo (FI)

(21) Appl. No.: 11/756,141

(22) Filed: May 31, 2007

(30) Foreign Application Priority Data
Dec. 22, 2006 (EP) 06026808.3

(51) Int. Cl. H04L 12/66; H04B 7/00; H04J 3/08

(52) U.S. Cl. 370/352; 370/278; 370/315; 455/500; 455/522

(57) ABSTRACT

The present disclosure relates to a method, system, apparatus, receiver module and computer program product for providing a power-efficient reception, wherein a transmission signal may be received via at least one selected or default receiving branch. It may be checked whether the transmission signal has been received successfully, and at least one additional receiving branch may be added to the at least one selected receiving branch for retransmission, if the transmission signal has not been received successfully. In an example embodiment, a trade-off between savings in power consumption and reduction in network capacity may be achieved.

Applicants hereby claim priority under 37 C.F.R § 1.55 based on EP Patent Application Number EP 06 026 808.3, filed in the European Patent Office on Dec. 22, 2006, entitled “Power-Efficient Multi-Branch Reception,” the disclosure of which is hereby incorporated by reference.

### TECHNICAL FIELD

The present disclosure relates to a method, system, apparatus, receiver module, and computer program product for providing power-efficient reception, such as in a system with at least two receiving branches or chains.

### BACKGROUND

Rising importance of wireless services has led to corresponding increased demand for higher network capacity and performance. Conventional options include higher bandwidth, optimized modulation or code-multiplex systems, but offer limited potential to increase spectral efficiency.

In so-called SIMO (Single Input Multiple Output) or MIMO (Multiple Input Multiple Output) systems antenna arrays are used to enhance bandwidth efficiency. MIMO systems provide multiple inputs and multiple outputs for a single channel and are thus able to exploit spatial diversity and spatial multiplexing. Further information about MIMO systems can be gathered from the IEEE specifications 802.11n, 802.16-2004 and 802.16e, as well as 802.20 and 802.22 which relate to other standards. Specifically, MIMO systems have been introduced to radio systems like e.g. WiMAX (Worldwide Interoperability for Microwave Access), and are currently standardized in 3GPP for WCDMA (Wideband Code Division Multiple Access) as well as 3GPP E-UTRAN (Enhanced Universal Mobile Telecommunications System (UMTS) Terrestrial Radio Access Network), such as LTE (Long Term Evolution) or 3.9G.

Different MIMO transmission modes in downlink may utilize different information in order to allow appropriate link adaptation. A mobile station (MS, also referred to as “user equipment” (UE) in 3D terminology) may have a linear or non-linear reception unit and Mr reception antennas, while the node B may have Mt transmission antennas. Based on partial or full channel state information (CSI) fed back from the MS, the BS may perform appropriate space-time processing such as multiuser scheduling, power and modulation adaptation, beamforming, and space-time coding. The CSI may include a channel direction information (CDI) and a channel quality information (CQI), which can be used for determining beamforming direction and power allocation.

In cellular systems, frequencies allocated to a service may be re-used in a regular pattern of areas, called ‘cells’, each covered e.g. by one base station. To ensure that the mutual interference between users remains below a harmful level, adjacent cells use different frequencies. In fact, a set of C different frequencies {f₁, . . . , f_{C}} can be used for each cluster of C adjacent cells. Cluster patterns and the corresponding frequencies may be re-used in a regular pattern over the entire service area. A frequency reuse factor of C=3 indicates a utilization of 1/3 of the available frequency spectrum, where most operational systems need to apply even higher frequency reuse factors in order to achieve full coverage. Preferably, the frequency reuse factor should be C=1 while still maintaining acceptable signal-to-interference (SIR) conditions even at cell borders. As an example, modem applications for 3.9G (3.9th Generation) communication systems will be deployed with frequency reuse factor C=1. One of the goals is to support high data rates and high spectral efficiency. The latter goal is achievable by applying MIMO techniques which require at least two receiver chains or branches in the user terminal.

Different radio algorithms (decoding, channel estimation, frequency synchronization and timing synchronization) are typically performed concurrently in each receiver branch or chain of multi-antenna or multi-branch receiver system, such as MIMO. The more critical the channel properties are, the more sophisticated baseband algorithms may need to be used for channel estimation and channel decoding. This may lead to high processing loads and corresponding high power consumption, which may be undesirable—especially for mobile applications such as mobile terminals or the like. However, not all possible applications demand high data rates which demand MIMO transmission schemes. An example of such an application is voice over Internet protocol (VoIP), i.e., a voice service. Additionally, various other applications are known which demand data rates lower than the maximum system data rates. An important user experience and differentiation factor is the available talk time for such voice services or other low data rate applications. It is thus important to consider means to decrease the power consumption of mobile devices.

### SUMMARY

An example embodiment may include receiving a transmission signal via at least one selected receiving branch, checking whether said transmission signal has been received successfully, and adding to said at least one selected receiving branch at least one additional receiving branch for retransmission, if said transmission signal has not been received successfully.

Another example embodiment may include a receiver for receiving information via at least one selected receiving branch, a checking unit for checking whether said information has been received successfully, and a switching unit for adding to said at least one selected receiving branch at least one additional receiving branch for retransmission, if said information has not been received successfully.

Another example embodiment may include a receiver module comprising a receiver configured to receive information via at least one selected receiving branch, a checking unit configured to check whether said information has been received successfully, and a switching unit configured to add to said at least one selected receiving branch at least one additional receiving branch for retransmission, if said information has not been received successfully.

Another example embodiment may include a computer program product being tangibly embodied on a computer-readable medium and being configured to cause a data processing apparatus to receive a transmission signal via at least one selected receiving branch, to check whether said transmission signal has been received successfully, and to add to said at least one selected receiving branch at least one additional receiving branch for retransmission, if said transmission signal has not been received successfully.

The details of one or more implementations are set forth in the accompanying drawings and the description below. Other features will be apparent from the description and drawings, and from the claims.

### BRIEF DESCRIPTION OF THE DRAWINGS

The present disclosure will now be described on the basis of example embodiments with reference to the accompanying drawings.

FIG. 1 shows a schematic block diagram of a multi-branch radio receiver apparatus according to an example embodiment.

FIG. 2 shows a schematic flow diagram of a branch selection operation according to an example embodiment.

FIG. 3 shows a schematic block diagram of a computer-implemented example embodiment.

### DESCRIPTION OF EMBODIMENTS

Example embodiments will now be described based on a multi-antenna radio apparatus which may be any type of device, component, circuit, module etc., such as—but not limited to—a wireless access device, a cellular base station device, a cellular telephone, a handheld computer, a multimedia device, or an integrated chip. The apparatus according to the embodiment may be employed in any wireless communication network which allows receipt of transmission signals via different receiving branches or chains. However, it is to be noted that the present disclosure is by no means intended to be limited to wireless multi-antenna apparatuses. Rather, it may be used, for example, in any receiver or transceiver apparatus which comprises at least two receiving branches or chains for receiving a signal transmitted over a wired or wireless medium.

More specifically, the multi-antenna radio apparatus according to an example embodiment may be a SIMO- or MIMO-based apparatus including different multi-antenna operating modes, e.g., SU-MIMO as well as MU-MIMO, for an exemplary case of two available receiving (Rx) antennas. It may be provided in an evolved Universal Mobile Telecommunications System (UMTS) Terrestrial Radio Access Network (EUTRAN) environment. However, it will be apparent from the following description and is therefore explicitly stressed that the present disclosure can be applied to any other network architecture with different radio access technologies involving multi-antenna transmitter devices, e.g., user terminals (such as user equipments (UEs), mobile stations or mobile phones), base station devices, access points or other access devices.

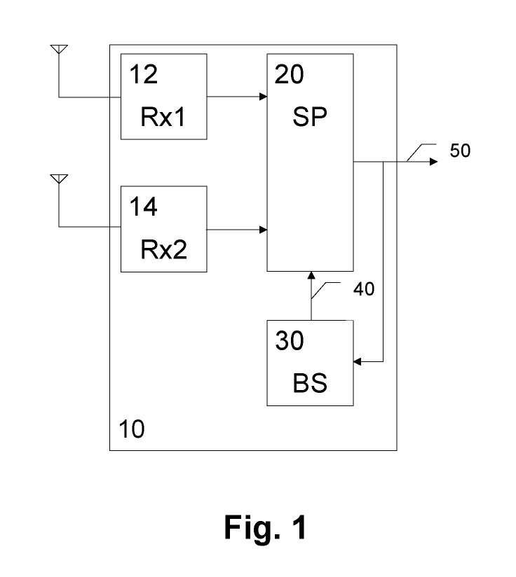

FIG. 1 shows a schematic block diagram of an exemplary multi-antenna radio apparatus 10, such as a mobile station (or UE in 3G terminology), which can be radio-connected to a base station device (not shown) or Node B (in 3G terminology) or other type of wireless access device. The radio apparatus 10 may also be any other wireless transmit/receive unit which comprises a multi-branch receiver functionality or module.

In the present example of FIG. 1, two antennas may be connected to a receiver with respective receiver units Rx1 12 and Rx2 14. Both antennas could also be connected to a single receiver unit having separate receiving branches or chains. The receiver units 12 and 14 may be further connected to a signal processing stage 20 which may be responsible for receiver-related processing, such as demodulating, descrambling, decoding etc. for a received transmission signal, in order to output received data 50. The signal processing stage 20 may be controlled by a branch selection functionality or unit 30 which may generate a branch selection control signal 40 based on a reception quality information issued by or derived from the signal processing stage 20, to thereby control the number of receiving branches or chains to be used for reception. In the present example of FIG. 1, one or both receiver units 12, 14 may be selected. It is noted that the branch selection control unit 30 does not need to be provided as a physically separate unit. The branch selection control unit 30 may be implemented as a discrete circuit part or additional software routine provided in the signal processing stage 20 or any other control function or processing device of the radio apparatus 10.

In MIMO mode transmission, if a packet at receiver decoding is in error, then a re-transmission may be requested, wherein the MIMO transmitter may use the same format to re-transmit the packet. In this example, the packet may be re-transmitted using the same error-encoded packet or may be re-transmitted using different error coding redundancy. The re-transmitted packet and erroneous packet may be combined in soft symbol form or may be decoded with the re-transmitted packet and erroneous packet as a code coming. This procedure is called hybrid automatic repeat request (H-ARQ) and may be used to derive the reception quality information used by the branch selection unit 30 to decide on selection of the used receiving branch(es). If H-ARQ retransmission is initiated, this may indicate that reception was not successful. Other reception quality indicators could be used for triggering branch selection.

According to an example embodiment, the radio apparatus 10 may be set to a single-branch operation mode where only one receiver branch or chain is activated or selected, although network deployment may demand usage of at least two Rx antennas. This single-branch operation mode may be selected for specific low data rate services (such as VoIP or the like) which may require less network capacity. Thereby, power consumption may be reduced.

The single-branch operation mode may be selected as a default setting or in dependence on an indication of a corresponding service which allows reduced network capacity. The one receiving branch or chain may be selected based on initial or continuous signal quality measurements of both receiving branches or chains, i.e., kind of selection diversity.

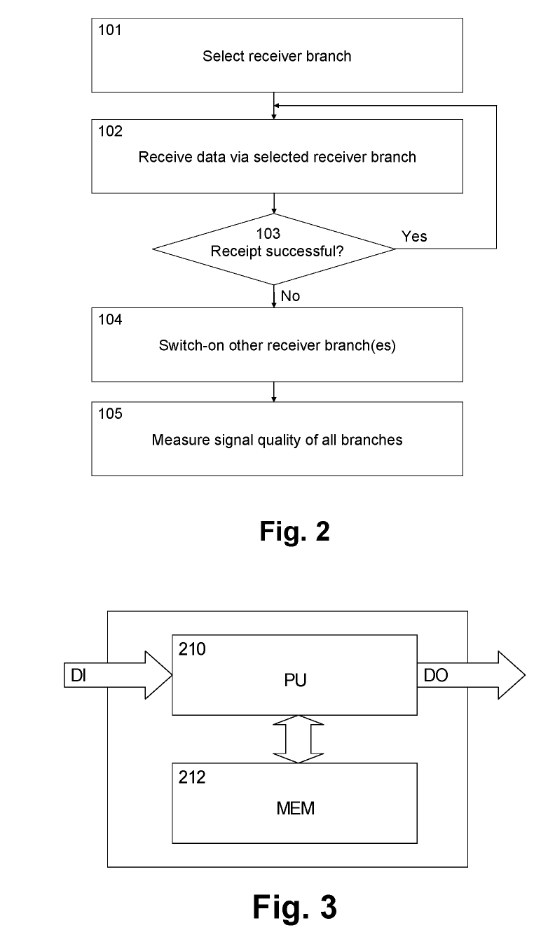

FIG. 2 shows a schematic flow diagram of a branch selection operation according to an example embodiment.

Initially, in block 101, a low data rate packet (e.g. VoIP packet) may be received with one receiver branch or chain, e.g. the signal processing stage 20 may be controlled by the branch selection unit 30 to select only one of the receiver units 12,14 for reception. This may be achieved based on a quality measurement and involve a corresponding control signaling between the signal processing stage 20 and/or the branch selection unit 30 on one hand, and the receiver units 12, 14 on the other hand, so as to deactivate or deselect one of the receiver units 12,14.

Then, in block 102, data may be received via the selected receiving branch or chain, and it may be checked in block 103 whether reception of a packet or signal portion was successful, e.g., based on a decision on H-ARQ retransmission as signaled by the reception quality information. If the reception was determined to be successful, i.e. no retransmission required, predetermined quality or signal-to-interference (SIR) threshold met, etc., the procedure may jump back to block 102 and wait for the receipt of the next packet or signal portion.

If reception is determined in block 103 to be unsuccessful, re-transmission of the same packet may be requested to the transmitting end (due to H-ARQ) and the branch selection unit 30 may issue a branch selection control information 40 so as to switch-on the available second receiver branch or chain in block 104, so that the retransmitted packet may be received via both receiver branches or chains. Also during this period, signal quality measurements of both or all branches may be performed in block 105.

It is noted that more than two receiver branches or chains may be provided, so that switching or selection may be performed for more than one branch or chain. Any number of receiving branches or chains may be selected and combined based on a desired quality and amount of power saving.

There are several ways to implement the switching to the two-branch or full-branch operation mode which may be a continuous mode for the remainder of the transmission or which may be re-evaluated based on quality measurements so as to selectively return to the single-branch or partial-branch operation mode.

The example embodiment described herein may provide a trade-off between savings in the power consumption and reduction in the network capacity. The trade-off may be controlled to favor either a low power consumption or a small reduction in the network capacity by selecting a suitable threshold value and by switching off the weaker antenna or branch only if the received signal level (or power) difference exceeds the pre-selected threshold value. Thereby, power consumption in the apparatus may be reduced in case of predetermined low data rate services, e.g., VoIP service. More specifically, the number of Rx antennas that are used may be determined by thresholding a feature or parameter related to signal quality. This feature or parameter could be, for example, the difference between respective signal strengths. In this example, the idea is that if the difference is large enough, the other branch may be switched off without substantially affecting detection performance. Another example is that if either of the antenna signals is strong enough, then the reception may be successful even without the other antenna.

Of course, other suitable selection criteria may be used. For example, information about the load of the network could be taken into account. That is, if the network is very loaded, there may be less single Rx branch usage. The information about the network load could be obtained in various ways. It could be signaled to the radio apparatus 10 by the network, or the load could be estimated by the radio apparatus 10. In the latter case, one possibility could be to analyze control channel information, such as allocation of time-frequency resources to radio apparatuses (e.g. UEs, mobile terminals, mobile stations, etc.) or indirect methods like total power measurements of a symbol, where only dedicated data is transmitted, etc.

The initial single-branch or partial-branch operation mode may be activated based on an information received from the transmitting side (e.g. base station device such as a base transceiver station (BTS) or node B) or network side, which informs the radio apparatus 10 (e.g. user terminal) that for some time interval only a low data rate service is scheduled to the radio apparatus 10.

The radio apparatus 10 may be enabled to detect that a first non-successful transmission has occurred based on a predetermined or known transmission timing of the data packets or signal portions, so that the radio transmitter 10 may know straight away if it has failed to receive one, and the signal processing stage 20 may generate a corresponding reception quality information to trigger selection of all or more receiving branches or chains. Hence, the H-ARQ process or any other reception quality determination process may be used to drive receiving branch selection control.

FIG. 3 shows a schematic block diagram of a software-based implementation of the proposed functionalities for achieving channel-sensitive complexity adjustment according to an example embodiment. These functionalities may be implemented with a processing unit 210, which may include, for example, any processor or computer device with a control unit which performs control based on software routines of a control program stored in a memory 212. Program code instructions may be fetched from the memory 212 and loaded to the control unit of the processing unit 210 in order to perform the processing steps of the above functionalities described in connection with the respective branch selection and signal processing blocks 20, 30 of FIG. 1 and the flow diagram of FIG. 2. These processing steps may be performed on the basis of input data DI and may generate output data DO, wherein the input data DI may correspond to output of a retransmission function and/or other quality indicator information, and the output data DO may correspond to control information used for selecting a corresponding number of receiving branches or chains.

A method, system, apparatus, receiver module and computer program product for providing a power-efficient reception have been described, wherein a transmission signal may be initially received via at least one selected or default receiving branch. Then, it may be checked whether the transmission signal has been received successfully, and at least one additional receiving branch may be added to the at least one selected receiving branch for retransmission, if the transmission signal has not been received successfully. Thereby, a trade-off between savings in power consumption and reduction in network capacity may be achieved.

The apparatus may be configured as a receiver apparatus, a transceiver apparatus which comprises an additional transmitting functionality or unit, or as a receiver module provided as a part or integrated circuit of a more complex apparatus or system.

Another example embodiment may include a communication system including at least one of the above apparatus and at least one transmitter for communicating with said apparatus.

Another example embodiment may include a computer program product including code (or code means) for producing the processes of the above methods when run on a computer device.

A reduced number of receiving branches or chains may be selectively used, so that a trade-off may be achieved between savings in power consumption and reduction in the network capacity. This trade-off may optionally be controlled to favor either a low power consumption or a small reduction in the network capacity e.g. by selecting a suitable threshold value so as to switch off a weaker antenna or branch only if the received signal level (or power) difference exceeds the pre-selected threshold value. Thereby, decreased power consumption can be achieved for low data rate services (e.g. VoIP services or the like). This may be useful and advantageous for mobile devices, such as mobile user terminals or the like. In an example embodiment, branch selection may be based on the difference between signal strengths received via available receiving branches. More specifically, an available receiving branch could be switched off, if the difference between a signal strength received via this available receiving branch and a signal strength received via another available receiving branch exceeds a predetermined threshold. As an additional or alternative option, an available receiving branch could be switched off, if signal strengths received via this available receiving branch and at least one other available receiving branch exceed a predetermined minimum strength.

As another additional or alternative option, a network load may be determined and the at least one selected receiving branch may be selected based on the result of the load measuring. In a first example, selection may be based on load information received from the network. In a second example, the network load may be estimated, wherein the selection is based on the estimated load.

As a default setting, the at least one selected receiving branch may be switched on and the at least one additional receiving branch may be switched off. Thereby, power consumption may be kept low initially and may be increased based on the actual environmental conditions and resulting reception quality. This default setting may be controlled, e.g. by the above mentioned switching unit.

The checking functionality may be based on or may comprise a determination as to whether a retransmission is initiated by a retransmission function. Thus, branch selection or receiver diversity control may be tied to re-transmission decisions, so that implementation of the control is facilitated. In a specific example, the proposed retransmission function may be a hybrid automatic repeat request (H-ARQ) function.

Furthermore, the receipt of the transmission signal may be based on a predetermined transmission timing, for example. That is, to obtain knowledge of a signal transmission and resulting possibility of receiving a signal even in cases where reception conditions via the reduced number of branches (e.g., only one branch) are so weak that detection would not be possible at all, the predetermined timing may be used to assume unsuccessful receipt and thus switch to the enhanced (or increased) number of branches (e.g., all branches).

In a specific implementation example, the transmission signal may be a voice signal transmitted over a packet-switched network, such as a VoIP (Voice Over IP) signal.

Reception via the at least one selected receiving branch may be continued, if the checking, e.g., by the above checking unit, reveals that the transmission signal has been received successfully, so that power consumption can be kept low.

As an additional option, the at least one selected receiving branch may be selected—e.g. as a default setting—based on the result of a signal quality measuring. This selection may be based on a predetermined threshold value, for example.

The proposed power-efficient branch selection, such as, for example, the above mentioned receiving, checking and adding, may be performed or activated only for at least one predetermined transmission service, for example. Optionally, an information may be signaled and received, which indicates the at least one predetermined transmission service.

It is to be noted that the present disclosure is not restricted to the embodiments described above, but may be implemented, for example, in any communication apparatus with a multi-branch or multi-chain receiver functionality for any type of wired or wireless application. As an example, the transmission signal may be received from a cable, optical fiber, or other type of electrical, magnetic, electromagnetic or optical waveguide. The processing steps of FIG. 2 may be implemented as discrete digital circuits, modules or logical signal processing structures. The embodiment may thus vary within the scope of the attached claims.

1. A method comprising:
receiving a transmission signal via at least one selected receiving branch;
checking whether said transmission signal has been received successfully; and
adding to said at least one selected receiving branch at least one additional receiving branch for retransmission, if said transmission signal has not been received successfully.

2. The method according to claim 1, further comprising providing a default setting where said at least one selected receiving branch is switched on and said at least one additional receiving branch is switched off.

3. The method according to claim 1, wherein said checking comprises determining whether a retransmission is initiated by a retransmission function.

4. The method according to claim 3, wherein said retransmission function is a hybrid automatic repeat request function.

5. The method according to claim 1, further comprising determining a receipt of said transmission signal based on a predetermined transmission timing.

6. The method according to claim 1, wherein said transmission signal is a voice signal transmitted over a packet-switched network.

7. The method according to claim 1, further comprising receiving further transmission signals via said at least one selected receiving branch, if said checking reveals that said transmission signal has been received successfully.

8. The method according to claim 1, further comprising measuring signal quality and selecting said at least one selected receiving branch based on a result of said signal quality measuring.

9. The method according to claim 8, further comprising performing said selecting based on a predetermined threshold value.

10. The method according to claim 9, wherein said selecting is based on a difference between signal strengths received via available receiving branches.

11. The method according to claim 10, wherein an available receiving branch is switched off, if the difference between the signal strengths received via said available receiving branches exceeds said predetermined threshold value.

12. The method according to claim 10, wherein an available receiving branch is switched off, if signal strengths received via said available receiving branches exceed a predetermined minimum strength.

13. The method according to claim 1, further comprising determining network load and selecting said at least one selected receiving branch based on a result of said determining network load.

14. The method according to claim 13, wherein said selecting is based on load information received from a network.

15. The method according to claim 13, further comprising estimating said network load, wherein said selecting is based on said estimating.

16. The method according to claim 1, further comprising performing said receiving, checking and adding only for at least one predetermined transmission service.

17. The method according to claim 16, further comprising receiving an information which indicates said at least one predetermined transmission service.

18. An apparatus comprising:
a receiver configured to receive information via at least one selected receiving branch;
a checking unit configured to check whether said information has been received successfully; and
a switching unit configured to add to said at least one selected receiving branch at least one additional receiving branch for retransmission, if said information has not been received successfully.

19. The apparatus according to claim 18, wherein said switching unit is configured to provide a default setting where said at least one selected receiving branch is switched on and said at least one additional receiving branch is switched off.

20. The apparatus according to claim 18, wherein said checking unit is configured to perform said checking by determining whether a retransmission has been initiated by a retransmission function.

21. The apparatus according to claim 20, wherein said retransmission function includes a hybrid automatic repeat request function.

22. The apparatus according claim 18, wherein said checking unit is configured to determine a receipt of said information based on a predetermined transmission timing.

23. The apparatus according to claim 18, wherein said information includes a voice signal transmitted over a packet-switched network.

24. The apparatus according claim 18, wherein said switching unit is configured to control said receiver to continue receiving via said at least one selected receiving branch, if said checking of said checking unit reveals that said information has been received successfully.

25. The apparatus according to claim 18, wherein said switching unit is configured to select said at least one selected receiving branch based on a result of a signal quality measurement.

26. The apparatus according to claim 25, wherein said switching unit is configured to select said at least one selected receiving branch based on a predetermined threshold value.

27. The apparatus according to claim 18, wherein said apparatus is configured to select said selected branch only for at least one predetermined transmission service.

28. The apparatus according to claim 27, wherein said apparatus is configured to receive said information which indicates said at least one predetermined transmission service.

29. The apparatus according to claim 18 wherein the apparatus is in communication with a transmitter.

30. The apparatus according to claim 18 wherein the apparatus is in communication with a transmitter apparatus.

31. A receiver module comprising:
a receiver configured to receive information via at least one selected receiving branch;
a checking unit configured to check whether said information has been received successfully; and
a switching unit configured to add to said at least one selected receiving branch at least one additional receiving branch for retransmission, if said information has not been received successfully.

32. The receiver module according to claim 31, wherein said receiver module is included in a wireless terminal device.

33. The receiver module according to claim 32, wherein said receiver module is included in a mobile station.

34. The receiver module according to claim 31, wherein said receiver module is included in a wireless access device.

35. The receiver module according to claim 34, wherein said receiver module is included in a base station.

36. A computer program product being tangibly embodied on a computer-readable medium and being configured to cause a data processing apparatus to:
receive a transmission signal via at least one selected receiving branch;
check whether said transmission signal has been received successfully; and
add to said at least one selected receiving branch at least one additional receiving branch for retransmission, if said transmission signal has not been received successfully.
